(19) United States
(12) Patent Application Publication
(10) Pub. No.: US 2009/0215297 A1
(43) Pub. Date: Aug. 27, 2009

(54) INTERNALLY-SEALED ELECTRICAL CONNECTOR

(76) Inventors: James E. Faoro, Tucson, AZ (US); James R. Myers, Tucson, AZ (US); W. Howard Poisl, Tucson, AZ (US)

Correspondence Address: Jonathan A. Platt;Renner, Otto, Boisselle & Sklar, LLP, 19th Floor, 1621 Euclid Ave., Cleveland, OH, 44115, US

(21) Appl. No.: 12/038,282

(22) Filed: Feb. 27, 2008

(51) Int. Cl. H01R 13/52

(52) U.S. Cl. 439/273

(57) ABSTRACT

An internally-sealed pass-through electrical connector includes electrical conductors for carrying electrical signals through the electrical connector, a connector body or shell surrounding the connector, and an organic adhesive material within the body or shell that fills space around the conductors and between the conductors and the connector body. The connector body includes a metal portion, such as an aluminum portion, that has a roughened surface to better allow the adhesive to adhere to it. The roughened surface may be a grit blasted surface. The connector body may also include a plastic portion, such as a molded lead organizer, to aid in positioning the leads. The adhesive may have a coefficient of thermal expansion that is matched to that of the metal portion of the connector body or shell. The organic adhesive may be an epoxy material. The electrical connector may have any of a variety of configurations.

### GOVERNMENT RIGHTS

This invention was made with government support under Government Contract Ground Based Missile, Contract No. HQ0006-01-C-0001/101616. The government may have certain rights in this invention.

### BACKGROUND OF THE INVENTION

1. Technical Field of the Invention

The invention is in the field of internally-sealed electrical connectors.

2. Description of the Related Art

Electronics installations in some circumstances have sealed enclosures that require sealed electrical interfaces. An example of such installations are electronics installations for spaceflight applications. In such installations glass-kovar hermetic electrical connectors have been employed in the past. In such connectors a connector shell and conductors are made of kovar, an iron-nickel-cobalt alloy having thermal expansion characteristics similar to those of borosilicate glass. Borosilicate glass is used to fill the space between the conductors and the shell. Such connectors are heated to get the glass to melt and fill the internal space of the kovar shell, and then are cooled to fuse the structure together. Glass-kovar connectors are heavy, difficult to produce, and expensive.

From the foregoing it will be appreciated that improvements would be desirable in electrical connectors for sealed enclosures.

### SUMMARY OF THE INVENTION

According to an aspect of the invention, an internally-sealed electrical connector includes an organic adhesive inside a connector shell or body, providing sealing around electrical conductors, between the conductors and the shell or body.

According to another aspect of the invention, an internally-sealed electrical connector includes an epoxy inside a connector shell or body, providing sealing around electrical conductors, between the conductors and the shell or body.

According to yet another aspect of the invention, an internally-sealed electrical connector has a metal body portion with a roughened inner surface.

According to still another aspect of the invention, an internally-sealed pass-through electrical connector includes: electrical conductors for carrying electrical signals; a connector body surrounding the electrical conductors; and an organic adhesive material filling space around the conductors and between the conductors and the connector body.

According to a further aspect of the invention, a method of making an internally-sealed electrical connector includes the steps of: roughening an inner surface of a metal body portion; placing electrical conductors in the metal body portion; and filling a space in the metal body portion with an organic adhesive, to internally seal the space in the metal body portion.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

In the annexed drawings, which are not necessarily to scale:

FIG. 1 is an oblique view of an internally-sealed pass-through electrical connector in accordance with an embodiment of the present invention;

FIG. 2 is an exploded view of the electrical connector of FIG. 1;

FIG. 3 is a high-level flow chart of a process of making the electrical connector of FIG. 1; and

FIG. 4 is an oblique view of an installation that includes the electrical connector of FIG. 1.

### DETAILED DESCRIPTION

An internally-sealed pass-through electrical connector includes electrical conductors or leads for carrying electrical signals through the electrical connector, a connector body or shell surrounding the connector, and an organic adhesive material within the body or shell that fills space around the conductors and between the conductors and the connector body. The connector body includes a metal portion, such as an aluminum portion, that has a roughened surface to better allow the adhesive to adhere to it. The roughened surface may be a grit blasted surface. The connector body may also include a plastic portion, such as a molded lead organizer, to aid in positioning the conductors or leads. The adhesive may have a coefficient of thermal expansion that is matched to that of the metal portion of the connector body or shell. The organic adhesive may be an epoxy material. The electrical connector may have any of a variety of configurations, for example including micro-D connectors.

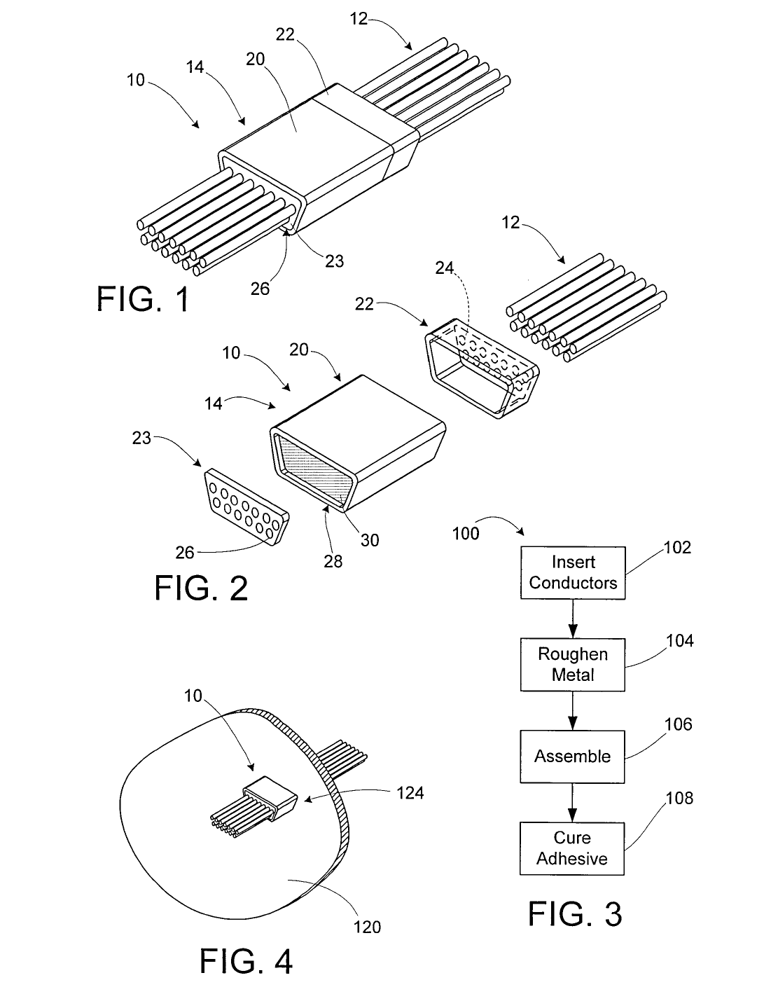

Referring initially to FIGS. 1 and 2, an electrical connector 10 includes electrical conductors 12 that pass thorough and are surrounded by a connector body 14. The conductors 12 are used for carrying electrical signals (broadly intended to embrace the concept of providing electrical coupling across the electrical connector 10). The conductors 12 may be standard copper wires or pins having a circular cross section. Alternatively, the conductors 12 may have other cross section shapes, such as rectangular or oval. The conductors 12 may alternatively be made from or include other electrically conductive metals or non-metals.

The connector body 14 surrounds and encloses portions of the conductors 12. The connector body 14 includes two parts, a metal body (or shell) portion 20, a plastic body (or shell) portion 22, and a contact insert 23. The plastic body portion 22, also referred to as a potting tray, includes holes 24 for allowing the conductors 12 to pass through in a predetermined arrangement. The arrangement of the holes 24 may correspond to any of a wide variety of conductor configurations for standard and non-standard types of connectors. Examples of such configurations include micro-D connector configurations having any of a variety of number of pins. The plastic body portion 22 is a molded plastic part, and may be made of a liquid crystal polymer or another suitable material.

The contact insert 23 also includes holes 26 that the conductors or contacts 12 pass through. The holes 26 of the contact insert 23 may correspond to the configuration of the holes 24 of the plastic body portion 22. The contact insert 23 may be made of a suitable molded plastic.

The plastic body portion 22 and the contact insert 23 are bonded to opposite sides of the metal body portion 20. A suitable structural (non-sealing) adhesive, such as an epoxy, may be used for the bonding. The plastic body portion 22 and the contact insert 23 provide proper spacing for the conductors 12 at the opposite ends of the metal body portion 20. The metal body portion 20 provides a strong outer shell that keeps the shape of the connector body 14. The metal body portion 20 may be made of any of variety of metals, an example being nickel-plated aluminum. Other examples include unplated aluminum, copper, and steel.

The connector body 14 encloses a volume or space 28 that is filled with an adhesive material 30. The conductors 12 enter one side of the space 28 through the holes 24 in the plastic body portion 22, and exit the opposite side of the space through the holes 26 in the contact insert 23. The adhesive material 30 seals the interior space 28 to prevent flow of gasses or other materials through the connector 10. The adhesive material is an organic material, and may be an epoxy material. An example of a suitable organic epoxy material is STYCAST 2850 FT, cured with Catalyst 11, both available from Emerson & Cuming, of Billerica, Mass., USA. More broadly, any suitably-matched-coefficient-of-thermal-expansion epoxy or polyurethane (with respect to a co-bonded metal component), which is also compatible metallic surfaces and the non-metallic insert, may be used.

It is advantageous for the adhesive material 30 to have a coefficient of thermal expansion that is matched to one or more of the materials of the other parts of the connector 10, and that maintains that match over a temperature range that is expected to be encountered by the connector 10 in use. To give an example to quantify the matching, it is desirable for the coefficient of thermal expansion of the adhesive material 30 to be within 10% of one or more of the materials of the other parts of the connector 10. More broadly, the coefficients of thermal expansion may be within a factor of two of each other, over the temperature range expected for operation. This closeness of coefficients of thermal expansion may continue to provide an adequate seal, such as within a leak rate of 10⁶ cc/sec of leakage of gaseous helium.

In particular, it is advantageous for the adhesive material 30 to have a coefficient of thermal expansion that is matched to that of the metal body portion 20. By matching the coefficient of thermal expansion of the adhesive material 30 and the metal body portion 20 to minimize stresses between the adhesive material 30 and the metal body portion 20. There is less of a concern with the stress and good sealing between the adhesive material 30 and the conductors 12. This is because it is highly unlikely for a crack or void to extend fully along the length of the interface between the adhesive material 30 and one of the conductors 12. This length of the interface between the conductors 12 and the adhesive material 30 may be 12.7 mm (0.5 inches), for example. The adhesive material 30 may also shrink during curing, which minimizes void formation between the adhesive material 30 and the conductors 12, while tending to produce void formation between the adhesive material 30 and the connector shell or body 14.

Minimizing stress between the adhesive material 30 and the metal body portion 20 has been found to be more important in preserving a seal across the connector 10. By minimizing the difference in the coefficients of thermal expansion of the adhesive material 30 and the metal body portion 20, there is less stress on the metal body portion 20 and the interface between the adhesive material 30 and the metal body portion 20. Matching the coefficients of thermal expansion also reduces the stress on the plastic body portion 22. Expansion of the adhesive material 30 relative to the metal body portion 20 causes stress on the connection between the plastic body potion 22 and the metal body portion 20. Matching the coefficients of thermal expansion reduces this stress, and decreases or eliminates the chance of connector failure at the connection between the body or shell portions 20 and 22.

The adhesive material 30 also should have a glass transition temperature that is equal to or greater than the expected maximum field of use temperature for the connector 10.

The adhesive material 30 does not have any metal fillers or other electrically conductive components in it. Metal fillers are often used to reduce the coefficient of thermal expansion of an organic adhesive. However it will be appreciated that metal fillers would disrupt the electrical isolation between various of the conductors 12, and between the conductors 12 and the metal body portion 20.

In addition, the metal body portion 20 has an inner surface 40 that is roughened in order to improve adherence between the adhesive material 30 and metal body portion 20. The roughened inner surface 40 may have a roughness number (ISO 1302) of 40 to 400. The inner surface 40 may be roughened by grit blasting. An example of a suitable grit blasting process is grit blasting using 410,000 Pa (60 psi) pressure and 380 grit, with a tip orifice of 6.4 mm (0.025 inches). Other suitable processes may be used.

The connector 10 produces many desirable characteristics for an internally-sealed electrical connector. The connector 10 has low leakage, is resistant to moisture, may be stored for long periods of time without adverse effects, is usable in low-pressure environments, and has good mechanical integrity. Leakage for the connector 10 has been found to about (on the order of) 10⁻⁸ cc/sec for helium at 1 atmosphere, a near hermetic leakage rate. In addition the connector 10 is significantly less expensive to produce and weighs significantly less than prior art glass-kovar connectors. The connector 10 may have less than half the weight of a similarly-sized prior art glass-kovar connector. This weight advantage may be of particular importance in weight-critical applications, such as aboard spacecraft or missiles. Another advantage relative to prior art glass-kovar connectors is that the connector 10 has better electrical performance, since the metal body portion 20 is well removed from the conductors 12 by a substantial thickness of intervening adhesive material.

It will be appreciated that a wide variety of alternate configurations of the connector 10 may be used. The size, shape, and number and/or configurations of wires/pins may be varied to obtain a wide range of electrical connector configurations. Also, the plastic body portion 22 and the contact insert 23 may have different locations and/or different configurations. It may possible to eliminate one of the body portion 22 and the contact insert 23.

FIG. 3 illustrates steps in a method 100 of making the electrical connector 10. In step 102 the conductors (pins) 12 are inserted into the plastic body portion 22. In step 104 the inner surface 40 of the metal body portion 20 is roughened. In step 106 the portions 20 and 22 of the connector body 14 are assembled, with the adhesive material 30 filling the space 28. Finally, in step 108 the adhesive material 30 is cured. The cure may be a room-temperature cure, followed by a low-temperature cure (e.g., no more than 65 degrees C.) for an extended period of time.

FIG. 4 shows the connector 10 being used to make an electrical connection through a wall 120 in a sealed chamber. The connector 10 is inserted in a hole 124 in the wall 120, and is sealed within the hole 124. The connector 10 may be coupled to mating connectors or any of a variety of electrical conductors, such as wires or ribbon cables.

From the forgoing it will be appreciated that the connector 10 provides a substantial advance over prior art internally-sealed connectors. Significant performance, cost, reliability, and weight advantages are all possible with connector 10.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. An internally-sealed pass-through electrical connector comprising:
electrical conductors for carrying electrical signals;
a connector body surrounding the electrical conductors; and
an organic adhesive material filling space around the conductors and between the conductors and the connector body.

2. The electrical connector of claim 1, wherein the connector body includes a metal body portion.

3. The electrical connector of claim 2, wherein the metal body portion has a roughened surface in contact with the adhesive.

4. The electrical connector of claim 3, wherein the roughened surface has a roughness number (ISO 1302) of 40 to 400.

5. The electrical connector of claim 3, wherein the roughened surface is a grit-blasted surface.

6. The electrical connector of claim 2, wherein the metal body portion includes aluminum.

7. The electrical connector of claim 6, wherein the aluminum of the metal body portion is nickel-plated aluminum.

8. The electrical connector of claim 2, wherein the connector body also includes a plastic body portion that has holes therein for receiving the conductors therethrough.

9. The electrical connector of claim 8, wherein the plastic body portion is bonded to the metal body portion.

10. The electrical connector of claim 9, wherein the connector body further includes a contact insert, attached to the metal body portion, and having the conductors passing therethrough.

11. The electrical connector of claim 8, wherein the plastic body portion is a molded plastic part.

12. The electrical connector of claim 1, wherein the adhesive is an epoxy.

13. The electrical connector of claim 1, wherein the adhesive has no electrically-conductive components.

14. The electrical connector of claim 1, wherein the electrical connector has a leakage rate of on the order of 10⁻⁸ cc/sec for helium at 1 atmosphere.

15. The electrical connector of claim 1, wherein the adhesive has a coefficient of thermal expansion that matches a metal portion of the connector body.

16. The electrical connector of claim 1, wherein the conductors are copper wires.

17. The electrical connector of claim 1, wherein the adhesive material has a glass transition temperature that is equal to or greater than the expected maximum field of use temperature for the electrical connector.

18. A method of making an internally-sealed electrical connector, the method comprising:
roughening an inner surface of a metal body portion;
placing electrical conductors in the metal body portion; and
filling a space in the metal body portion with an organic adhesive, to internally seal the space in the metal body portion.
